(19) United States
(12) Patent Application Publication
(10) Pub. No.: US 2004/0245278 A1
(43) Pub. Date: Dec. 9, 2004

(54) Propane tank vending machine

(76) Inventors: Lowell G. Steffens, Hale, MI (US); Brent D. Pusz, Canton, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/768,369

(22) Filed: Jan. 30, 2004

Related U.S. Application Data
(60) Provisional application No. 60/443,753, filed on Jan. 30, 2003.

(51) Int. Cl. B65H 3/00; B65G 59/00; G07F 11/16

(52) U.S. Cl. 221/265

(57) ABSTRACT

A propane tank vending machine has a generally box-shaped enclosure with a door at one side and a rotator assembly rotatably mounted inside. The rotator assembly has three vertically stacked trays each having a plurality of storage locations for releasably receiving upright propane tanks. The door is connected to an indexing assembly rotates the rotator assembly a distance of one storage location when the door is opened and prevents further rotation until the door is reopened.

### CROSS-REFERENCE TO RELATED APPLICATION

This application claims the benefit of U.S. provisional patent application Ser. No. 60/443,753 filed Jan. 30, 2003.

### BACKGROUND OF THE INVENTION

The present invention relates generally to vending and dispensing machines and in particular to such a machine for vending a plurality of relatively large articles, such as propane storage tanks.

Standard valved cylinders for propane gas, such as the type typically used for outdoor grilles, pose vending problems. These cylinders have a cylindrically shaped tank, a base mounted to the bottom of the tank, a valve at the top of the tank, and a guard substantially encircling the valve and providing a pair of lifting handles. The base and the guard have diameters smaller than the diameter of the outer surface of the tank. These standard propane cylinders can be relatively heavy, at least 20 pounds, and difficult for some customers to lift and manipulate.

The U.S. Pat. No. 1,530,288 shows a vending machine for cylinders of compressed gas and fluid. The machine includes an outer cabinet having an opening in the top of the cabinet, an opening at the bottom of the cabinet, and a serpentine passage for horizontally oriented cylinders within the cabinet extending from the top opening to the bottom opening. An empty cylinder is placed in the top opening and a crank arm is rotated which inserts the empty container into the cabinet and moves the container forward into the passage to release a full container out the bottom opening. This machine would require an unreasonable amount of lifting and manipulation of a standard propane cylinder. Accordingly, there is a need in the art for an improved vending machine for valved cylinders of compressed gas.

The U.S. Pat. No. 4,778,042 shows a vending machine for cylinders of compressed gas. The machine includes an outer cabinet having a door opening, a storage chain conveyer for horizontally oriented cylinders within the cabinet, and a rotatable transfer cradle between the door opening and the conveyer which prevents access to the conveyor. The transfer cradle is provided with sensors so that a data processor can identify an empty cylinder placed in the transfer cradle through the door opening. Thereafter, the transfer cradle and conveyor are operated to load the empty cylinder into the conveyor and to unload a full cylinder from the conveyor into the transfer cradle for extraction through the door opening. This machine is relatively complex and expensive to produce. Additionally, this machine would require an unreasonable amount of lifting and manipulation of a standard propane cylinder.

The U.S. Pat. No. 5,829,630 shows a propane cylinder vending machine having a cabinet with first and second openings sized to allow the valved cylinders to pass therethrough in an upright orientation. A conveyor is provided within the cabinet, which extends from the first opening to the second opening to move the cylinders therebetween. The conveyor supports the cylinders in an upright orientation. An empty cylinder verification system and an anti-theft system having mechanically inner and outer doors are provided.

It remains desirable to provide an effective and efficient vending machine for vending articles including propane tanks and the like that allows only a single article to be dispensed at the time of vending while also allowing exchange of the articles and preventing theft of the articles.

### SUMMARY OF THE INVENTION

The present invention concerns a propane tank vending machine that includes a generally rectangular box-shaped frame enclosed except at a front side, the sides defining an interior portion of an enclosure. The vending machine includes a rotator assembly rotatably mounted in the interior of the enclosure, the rotator assembly being operable to receive a plurality of propane tanks. A door member is hingedly attached to the frame at the front side. The door member is connected to an indexing assembly that is operable to rotate the rotator assembly when the door member is moved from a door closed position to a door open position. The rotator assembly is configured to present only one storage location at a time when the door is open.

In a preferred embodiment, the rotator assembly has three trays vertically stacked and each tray has eight storage locations defined by dividers. The indexing assembly includes a first arm for enabling the rotator assembly to rotate and a second arm for rotating the rotator assembly. The rotator assembly has a plurality of apertures formed therein each corresponding to one of the storage locations and the indexing assembly includes a pin for selectively engaging the apertures to prevent rotation of the rotator assembly. The rotator assembly also includes a lever arm mounting the pin, the lever arm being in a normal position with the pin engaging one of the apertures when the door member is in the closed position and the lever arm being moved by engagement with the first arm to a released position disengaging the pin from the one of the apertures. The rotator assembly further includes a plurality of projections, the second arm engaging one of the projections during an opening of the door member to rotate the rotator assembly.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a fragmentary perspective view of a vending machine in accordance with the present invention shown in a door closed position;

FIG. 2 is an exploded fragmentary view of the vending machine shown in FIG. 1 in a door open position;

FIG. 3 is an enlarged exploded perspective view of the indexing and rotating assembly shown in FIG. 2; and

FIG. 4 is a perspective bottom view of the lower tray of the rotator assembly shown in FIG. 2.

### DESCRIPTION OF THE PREFERRED EMBODIMENT

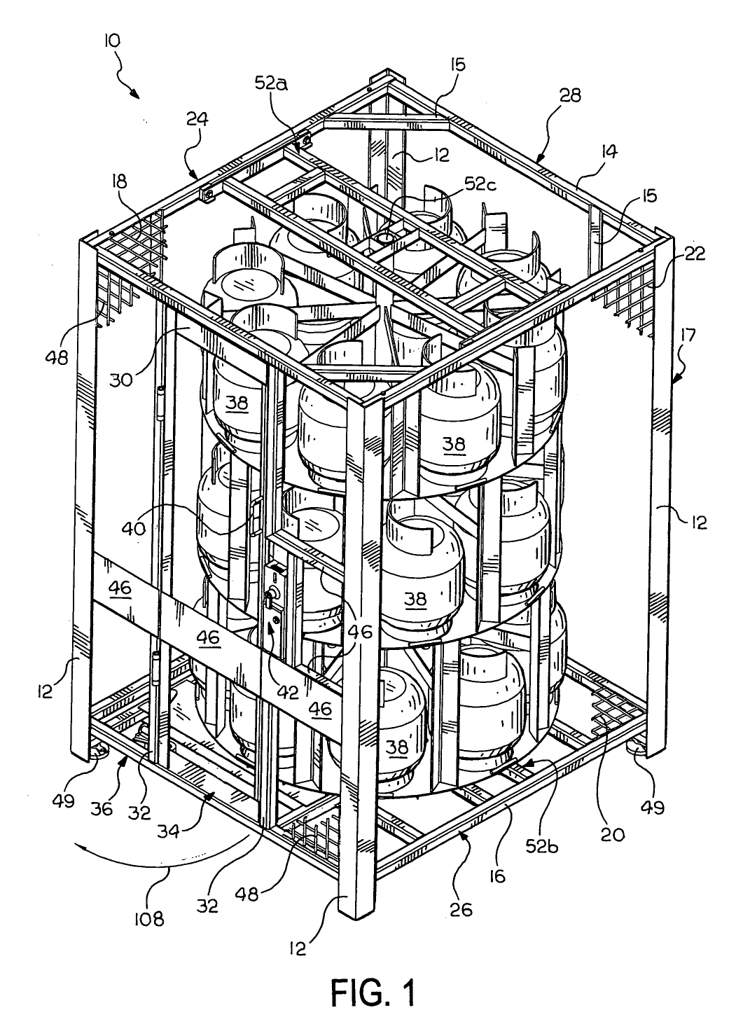

Referring now to FIG. 1, a propane tank vending machine or unit in accordance with the present invention is indicated generally at 10. The propane tank vending machine 10 includes a plurality of vertical support members 12 extending between a generally square or rectangular upper frame 14 and a generally square or rectangular lower frame 16, forming a generally rectangular box-shaped frame, indicated generally at 17. The upper frame includes a plurality of bracing members 15 extending across corners of the upper frame 14 to provide stiffness and support thereto. A generally planar overhead or top member 18 and a generally planar base member 20 extend across the upper frame 14 and the lower frame 16, respectively, to enclose a top and a bottom respectively of the vending machine 10. A wall 22 is representative of walls extending between pairs of the support members 12 and the frames 14 and 16 to enclose a left side 24, a right side 26, and a rear side 28 of the vending machine 10. Preferably, the top member 18, the base member 20, and the walls 22 are constructed of a wire mesh material or the like. The top member 18, the base member 20, and the walls 22 enclose five of the six planar surfaces of the vending machine 10 while advantageously allowing users of the vending machine 10 to view the contents thereof.

A door member 30 is hingedly mounted along one vertical edge to a one of two spaced vertical door frame members 32 to enclose a door opening 34 between the door frame members 32 on a front side 36 of the vending machine 10. The door frame members 32 extend between the upper frame 14 and the lower frame 16 at the front side 36 of the vending machine 10. The width of the door opening 34 is sized to allow a standard-sized propane tank 38 aligned therewith to pass therethrough. The open space between each of the door frame members 32 and the adjacent support member 12 is such that a standard-sized propane tank 38 will not pass therethrough. The door member 30 includes a handle 40 attached to an exterior surface thereof for moving the door member 30 between closed and open positions as discussed in more detail below. A locking mechanism 42 is attached to a plurality of frame members 44 on the front side 36 of the vending machine 10 adjacent the door member 30. The locking mechanism 42 is preferably a coin or token operated locking device, such as one commercially available from Monarch Coin & Security, Inc., Covington, Ky., or similar device, to allow for limited access to the vending machine 10.

A plurality of horizontal support members 46 extend between the support members 12 and the door frame members 32 for providing stiffness and support to the vending machine 10. The spaces formed between the support members 12, the door frame members 32, the frame members 44, and the horizontal support members 46 is enclosed by a plurality of walls 48, each of which are preferably constructed of a wire mesh material similar to the top member 18, the base member 20, and the walls 22 to enclose the vending machine 10 while advantageously allowing users of the vending machine 10 to view the contents thereof. A stabilizer foot 49 is attached to a lower end of each of the support members 12 to provide stability to the vending machine 10. The stabilizer foot 49 may include a conventional vertical threaded fastener for leveling the ending machine 10. Alternatively, a conventional caster with a foot-operated lock could be substituted for the ground engaging portion of the foot 49.

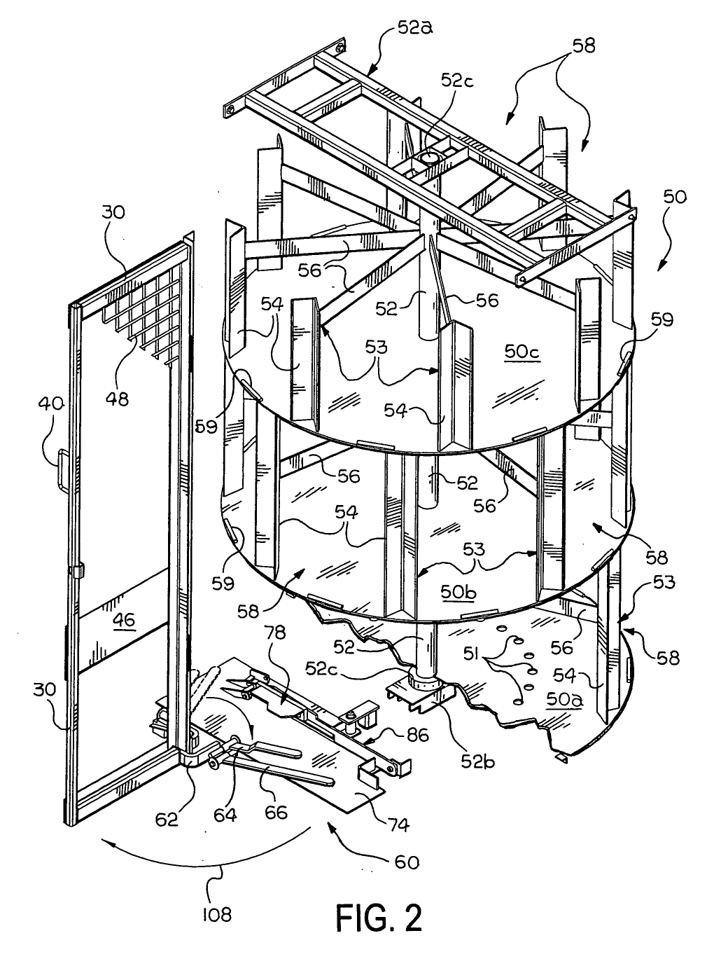

Referring now to FIGS. 1 and 2, a rotator assembly, indicated generally at 50, is disposed in an interior of the above-described enclosure of the vending machine 10 and includes a generally disk-shaped first or lower tray 50a, a generally disk-shaped second or middle tray 50b, and a generally disk-shaped third or upper tray 50c. Each of the trays 50a, 50b and 50c is fixedly mounted at a central aperture thereof on a vertical shaft member 52. The shaft member 52 is rotatably mounted at opposite ends to the upper frame 14 by an upper support assembly 52a, extending across the upper frame 14 between the sides 24 and 26, and to a similar lower support assembly 52b attached to the lower frame 16. Preferably, each of the support assemblies 52a and 52b includes a bearing 52c disposed therein to allow the shaft member 52 to rotate. Each of the trays 50a, 50b, and 50c is adapted to receive a plurality of propane tanks 38, best seen in FIG. 1. Each of the tanks 38 rests in an upright position on an upper surface of one of the trays, 50a, 50b or 50c, between an adjacent pair of a plurality of spaced apart retaining members or dividers 53 extending upwardly from the upper surfaces of the trays 50a, 50b, or 50c. Each of the dividers 53 includes a substantially vertical beam 54 mounted adjacent a periphery of the associated one of the trays 50a, 50b, or 50c and a horizontal beam 56 extending between the shaft 52 and an upper portion of the vertical beam 54. Preferably, the dividers 53 are evenly spaced apart in a circle extending around the shaft 52 to define a plurality of tank storage locations 58 each sized to receive one of the standard-size propane tanks 38. Each of the trays 50a, 50b and 50c is sized for eight of the storage locations 58 for a total of twenty-four. Each storage location 58 is further defined by a stop 59 extending upwardly from the upper surface of the associated tray 50a, 50b and 50c. The stops 59 are disposed substantially equidistant between the dividers 53 that define each of the storage locations 58 and are attached at the periphery of the associated tray. Alternatively, any suitable number of dividers 53 can be used depending upon the diameter of the trays 50a, 50b and 50c and the size of the objects to be vended. Preferably, when the trays 50a, 50b, and 50c are attached to the shaft member 52, the mounting locations 58 are vertically staggered or offset such that only one of the storage locations 58 is accessible through the door opening 34 at a time as discussed in more detail below.

The lower tray 50a includes a plurality of equally radially spaced apertures 51 extending therethrough. The apertures 51 are equal in number to the total number of tank storage locations 58 on the rotator assembly 50. An indexing and rotating assembly, indicated generally at 60, is attached to a lower portion of the door member 30. The assembly 60 is operable to rotate the rotator assembly 50 from one aperture 51 to the next aperture 51 each time the door member 30 is moved from the closed position, shown in FIG. 1, to the open position, shown in FIG. 2.

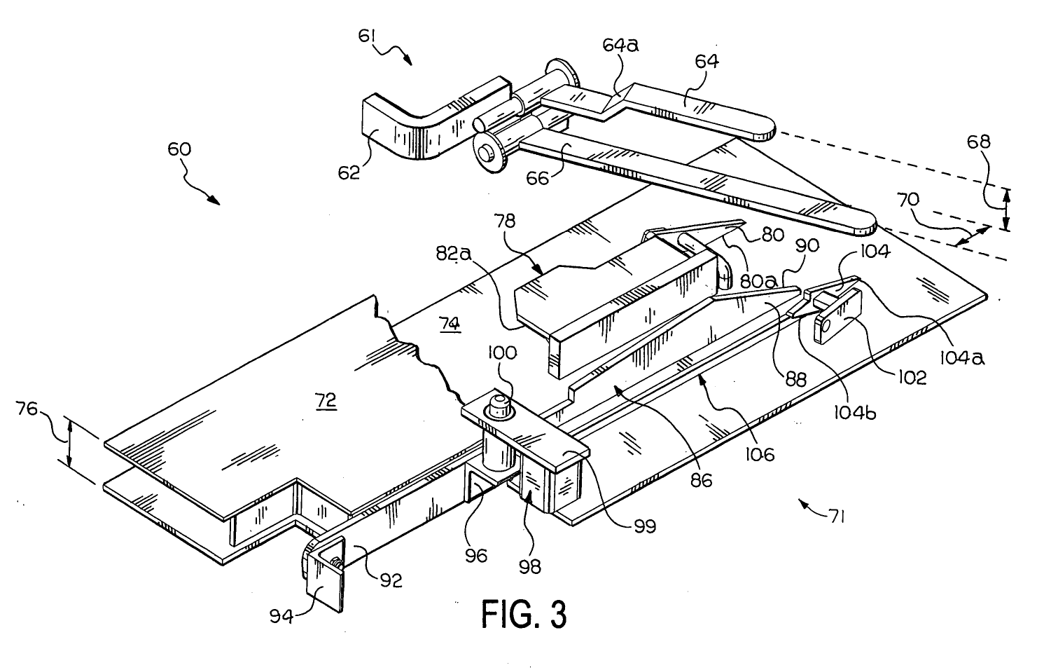

Referring now to FIG. 3, the indexing and rotating assembly 60 is shown in greater detail. The assembly 60 includes a rotating assembly, indicated generally at 61, having a generally L-shaped base 62 attached to a lower portion of the door member 30. When the door member 30 is moved from the closed position to the open position, the base 62 moves with it. An upper swing arm 64 and a lower swing arm 66 are attached to and extend outwardly from a portion of the base 62 adjacent the inner surface of the door member 30. The upper swing arm 64 preferably includes an offset portion 64a. The swing arms 64 and 66 are spaced apart vertically on the base 62 by a distance indicated by an arrow 68. The respective longitudinal axes of the swing arms 64 and 66 are spaced apart horizontally by a distance indicated by an arrow 70. The assembly 60 also includes a fixed assembly, indicated generally at 71, having an upper plate 72, partially cut away, and a lower plate 74 spaced apart as indicated by an arrow 76. The upper plate 72 and the lower plate 74 are each attached to the lower frame 16 by any suitable means such as by fasteners, a welded connection, or the like.

A guide member 78 includes a ramped portion 80 and a horizontal planar portion 82. The ramped portion 80 is pivotally attached to the upper plate 72. The planar portion 82 is fixedly attached to a support member 84 extending upwardly from the upper plate 72 and is disposed above the upper plate 72 by a predetermined distance. An angled surface 80a of the ramped portion 80 is adapted to rest on an upper surface of the upper plate 72.

A lever arm 86 includes a free first end 88 having a ramped surface 90 and a second end 92 pivotally attached to the lower frame 16 by an attachment bracket 94. A pin assembly 98 includes a pin support 96 that extends outwardly from the lever arm 86 intermediate the first end 88 and the second end 92. The pin assembly 98 also includes a pin guide 99 attached to the lower frame 16 and a pin 100 mounted on the pin support 96 and extending upwardly through an aperture in the pin guide 99. A spring (not shown) biases the pin 100 in an extended position shown in FIG. 3. In the extended position, the pin 100 engages with a one of the apertures 51 formed in the lower tray 50a, preventing the rotator assembly 50 from rotating. A bracket 102 is attached to the lower plate 74 adjacent the lever arm 86 and includes a ramp 104 pivotally attached thereto. The ramp 104 includes a forward ramped surface 104a and a rear ramped surface 104b. A groove 106 is formed in the lower plate 74 below the lever arm 86 and is sized to permit the lever arm 86 to pass therethrough.

When the door member 30 is moved from moved from the closed position (FIG. 1) to the open position (FIG. 2), the swing arms 64 and 66 of the rotating assembly 61 move in a direction indicated by an arrow 108, best seen in FIG. 2. As the assembly 61 moves, the lower swing arm 66 first engages with the ramp 104 and begins to travel up the forward ramped surface 104a and then engages the ramped surface 90 of the lever arm 86. As the assembly 61 continues to move, the swing arm 66 begins to displace the lever arm 86 downwardly under the influence of gravity and the lever arm 86 pivots about the second end 92 attached to the attachment bracket 94. The lever arm 86 displaces downwardly into the groove 106 and, as the lever arm 86 moves downwardly, the pin 100 is retracted from the aperture 51 through the aperture in the pin guide 99. Now the rotator assembly 50 is free to rotate.

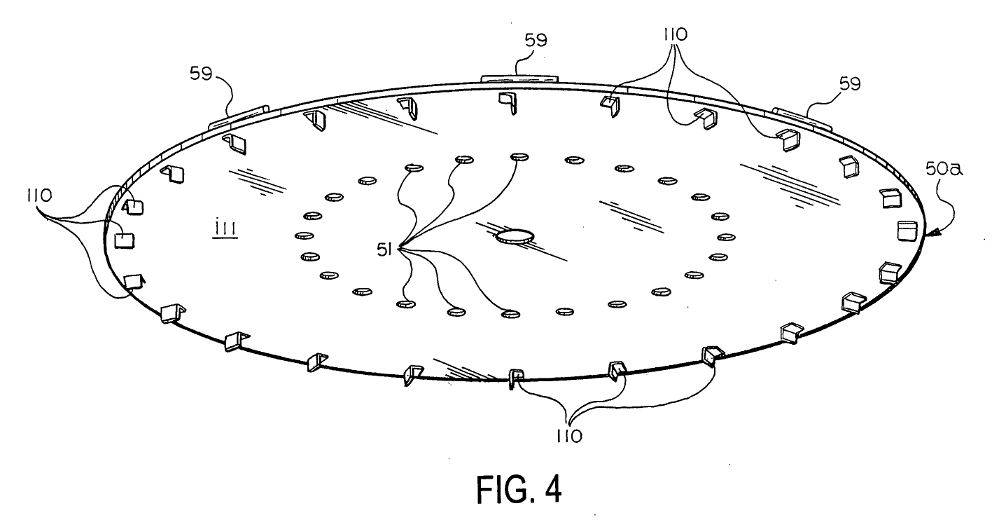

After the lower swing arm 66 engages the ramped surface 90 of the lever arm 86, and as the rotating assembly 61 continues to move, the upper swing arm 64 later engages with and travels up the ramped portion 80 of the guide member 78 and engages the planar portion 82 of the guide member 78. When the upper arm 64 engages with the planar portion 82, the upper arm 64 is disposed directly below the lower tray 50a. At or near the same time as the lower arm 66 moves the pin 100 downwardly, the upper arm 64 engages with a one of a plurality of projections 110, best seen in FIG. 4, extending downwardly from a lower surface 111 of the lower tray 50a. The number of the projections 110 corresponds to the number of apertures 51 and to the number of mounting locations 58 on the rotator assembly 50. As the upper arm 66 engages the projection 110, the lower arm 64 has moved the lever arm 86 downwardly into the groove 106 and moved the pin 100 downwardly, which disengages the pin 100 from the aperture 51 and allows the rotator assembly 50 to rotate. The force utilized to move the door member 30, therefore, is utilized to rotate the rotator assembly 50 when the upper arm 66 engages the projection 110.

Assuming the rotating assembly 61 continues to move in the direction 108, the upper arm 64 continues to move the rotator assembly 50 until the upper arm 64 reaches a trailing edge 82a of the planar portion 82 of the guide member 78. When the upper arm 64 reaches the trailing edge 82a, the arm 64 drops to an upper surface of the lower plate 72, disengaging from the projection 110 and ceasing to rotate the rotator assembly 50. At or about the same time as the upper arm 64 drops, the lower arm 66 reaches a point in its travel in the direction 108 where it disengages from the lever arm 86. When the lower arm 66 disengages from the lever arm 86, the spring (not shown) returns the lever arm to its rest position, and the pin 100 returns to the extended position. The predetermined distance traveled by the rotator assembly 50 is such that when the pin 100 returns to the extended position, the pin 100 engages with the next aperture 51 that adjacent to the one of the apertures 51 from which it had previously been disengaged. The pin 100, when engaged in a one of the apertures 51 prevents the rotator assembly 50 from being rotated and prevents the removal of more than one of the propane tanks 38 while the door member 30 is open.

The door member 30 is fully opened at substantially 90° from the closed position. The assembly 60 allows the rotator assembly 50 to rotate only a predetermined angular distance when the door member 30 is moved from the fully closed position to the fully open position. The assembly 60 also prevents movement of the rotator assembly 50 while the door member 30 remains open. With the configuration shown, each time the door 30 is opened, the indexing and rotating assembly 60 will rotate the rotator assembly 50 15°.

While the present invention has been described wherein the rotator assembly 50 is rotated 15°, those skilled in the art will realize that the configuration may be altered to rotate the assembly 50 for any desired radial angle depending on the size and the number of the articles to be vended.

Preferably, the locking mechanism 42 is coin-operated or token-operated wherein the door member 30 may be opened only when a coin(s) or token(s) is inserted into the locking mechanism 42 thereby permitting unattended operation. The propane tank vending machine 10 is capable of dispensing filled propane cylinders 38 and is also advantageously capable of exchanging an empty single cylinder 38 for a single full cylinder 38. Preferably, the door member 30 includes a spring-loaded device (not shown) or similar device such that if the door member 30 is left open, it will close on its own.

Furthermore, the propane tank vending machine 10 is designed to permit an authorized person to insert a “hand held” tool when the door member 30 is opened to depress the lever arm 86 thereby disengaging the pin 100 and allowing free rotation of the rotator assembly 50 for loading and unloading the cylinders 38.

In accordance with the provisions of the patent statutes, the present invention has been described in what is considered to represent its preferred embodiment. However, it should be noted that the invention can be practiced otherwise than as specifically illustrated and described without departing from its spirit or scope. While propane tanks or cylinders have been described, the machine according to the present invention can be used to vend any suitable item.

What is claimed is:

1. An apparatus for vending a plurality of articles, comprising:
an enclosure having closed sides and a hollow interior, said enclosure having a door opening formed in one of said sides;
a rotator assembly rotatably mounted in said hollow interior of said frame, said rotator assembly having a plurality of angularly spaced storage locations each for releasably retaining an article to be vended;
a door member hingedly attached to said frame and operable to be moved between a closed position blocking said door opening and an open position permitting access to said rotator assembly through said door opening; and
an indexing assembly connected to said door member and to said rotator assembly, said indexing assembly being operable to rotate said rotator assembly to move one of said storage locations away from said door opening and move another one of said storage locations to said door opening to access an article at said another one of said storage locations through said door opening when said door member is moved from the closed position to the open position.

2. The apparatus according to claim 1 including a locking mechanism attached to said door member and said enclosure and being operable to lock and unlock said door member.

3. The apparatus according to claim 2 wherein said locking mechanism is token-operated.

4. The apparatus according to claim 1 wherein said rotator assembly includes at least two article supporting trays in a stacked relationship, each of said trays having a predetermined number of said storage locations, said storage locations of one of said trays being angularly displaced with respect to said storage locations of another one of said trays.

5. The apparatus according to claim 1 wherein said storage locations are each sized to retain a single standard-sized propane tank in an upright position.

6. The apparatus according to claim 1 wherein adjacent ones of said storage locations are separated by dividers.

7. The apparatus according to claim 6 wherein said dividers each include a vertical beam adjacent a periphery of said rotator assembly and a horizontal beam extending from an upper portion of said vertical bean radially inwardly.

8. The apparatus according to claim 1 wherein said rotator assembly includes a stop mounted at each of said storage locations at a periphery of said rotator assembly.

9. The apparatus according to claim 1 wherein said indexing assembly includes a first arm for enabling said rotator assembly to rotate and a second arm for rotating said rotator assembly.

10. The apparatus according to claim 9 wherein said rotator assembly has a plurality of apertures formed therein each corresponding to one of said storage locations and said indexing assembly includes a pin for selectively engaging said apertures to prevent rotation of said rotator assembly.

11. The apparatus according to claim 10 wherein said rotator assembly includes a lever arm mounting said pin, said lever arm being in a normal position with said pin engaging one of said apertures when said door member is in the closed position and said lever arm being moved by engagement with said first arm to a released position disengaging said pin from said one of said apertures.

12. The apparatus according to claim 9 wherein rotator assembly includes a plurality of projections, said second arm engaging one of said projections during an opening of said door member to rotate said rotator assembly.

13. An apparatus for vending a plurality of propane tanks, comprising:
an enclosure having closed sides and a hollow interior, said enclosure having a door opening formed in one of said sides;
a rotator assembly rotatably mounted in said hollow interior of said frame, said rotator assembly having at least two vertically stacked trays each having a plurality of angularly spaced storage locations each for releasably retaining a propane tank to be vended;
a door member hingedly attached to said frame and operable to be moved between a closed position blocking said door opening and an open position permitting access to said rotator assembly through said door opening; and
an indexing assembly connected to said door member and to said rotator assembly, said indexing assembly being operable to rotate said rotator assembly to move one of said storage locations away from said door opening and move another one of said storage locations to said door opening to access one of the propane tanks at said another one of said storage locations through said door opening when said door member is moved from the closed position to the open position.

14. The apparatus according to claim 13 wherein said rotator assembly includes at least two article supporting trays in a stacked relationship, each of said trays having a predetermined number of said storage locations, said storage locations of one of said trays being angularly displaced with respect to said storage locations of another one of said trays.

15. The apparatus according to claim 14 wherein said storage locations are each sized to retain a single standard-sized propane tank in an upright position.

16. The apparatus according to claim 14 wherein adjacent ones of said storage locations are separated by dividers.

17. The apparatus according to claim 14 wherein said indexing assembly includes a first arm for enabling said rotator assembly to rotate and a second arm for rotating said rotator assembly.

18. The apparatus according to claim 17 wherein said rotator assembly has a plurality of apertures formed therein each corresponding to one of said storage locations and said indexing assembly includes a pin for selectively engaging said apertures to prevent rotation of said rotator assembly.

19. The apparatus according to claim 17 wherein said rotator assembly includes a lever arm mounting said pin, said lever arm being in a normal position with said pin engaging one of said apertures when said door member is in the closed position and said lever arm being moved by engagement with said first arm to a released position disengaging said pin from said one of said apertures.

20. The apparatus according to claim 17 wherein rotator assembly includes a plurality of projections, said second arm engaging one of said projections during an opening of said door member to rotate said rotator assembly.
